(19) United States
(12) Patent Application Publication
(10) Pub. No.: US 2019/0286116 A1
(43) Pub. Date: Sep. 19, 2019

(54) METHOD FOR ERROR DETECTION AND INSTALLATION FOR MACHINING A WORKPIECE

(71) Applicant: HOMAG GmbH, Schopfloch (DE)

(72) Inventors: Stefan ROTHFUSS, Baiersbronn (DE); Michael ZETZSCHE, Albstadt (DE)

(21) Appl. No.: 16/352,762

(22) Filed: Mar. 13, 2019

(30) Foreign Application Priority Data
Mar. 15, 2018 (DE) 10 2018 203 977.1

(51) Int. Cl. G05B 23/02

(52) U.S. Cl. CPC G05B 23/0262; G05B 23/0267

(57) ABSTRACT

Method for error detection and for local limitation of a cause of the error in an installation for machining a workpiece which is preferably formed at least in sections from wood, a wood material, and/or a synthetic material, with the installation having several segments. The method comprises the steps: Detecting a status information which relates to a workpiece throughflow in at least two segments of the installation; determining whether there is an error on the basis of the status information; if there is an error, identifying in which of the at least two segments of the installation the error is present for local limitation of the cause of the error; and outputting a signal containing the information regarding which segment the error is in.

The present invention relates to a method for error detection and for local limitation of a cause of the error in an installation for machining a workpiece which is preferably formed at least in sections from wood, a wood material, and/or a synthetic material. The present invention further relates to the use of such a method, a data carrier upon which a program is stored that is suited to performing the method, a sensor equipment set for an installation for machining a workpiece, and an installation for machining a workpiece.

Installations for machining a workpiece with conveyor belts upon which workpieces are conveyed are often operated with a high through-put speed. For example, in an industrial edging installation for wood workpieces in which the latter are provided with a solid wood edge or a paper edge—as they are used in furniture manufacturing—between 8000 and 12000 workpieces are processed per day in some cases.

Experience shows that in such high-performance installations, a performance loss can occur, the cause of which is not easy to establish. Sometimes such a performance loss also occurs gradually, so that the number of machined workpieces per day slowly decreases and the decrease is not immediately recognized. If the performance then drops noticeably at some time (by 10 or 20 percent, for example), it is therefore certain that there is an error in the installation—for example, a fault in a conveyor belt or a machine—however, it is unclear where the error comes from. Moreover, such an appreciable drop in performance as such is not desirable, however, earlier intervention may not be feasible for economic reasons.

The error detection therefore often occurs late after a gradual performance loss has already continued over a certain time period until a perceivable drop in the performance of the installation becomes noticeable. Since the workpiece machining installations are, as a rule, complexly structured and are equipped with several machining aggregates (for example, a sawing aggregate, a drilling aggregate, a gluing aggregate, a pressing aggregate, a welding aggregate, etc.) as well as conveyor belt sections lying in between, identifying the cause of an error following the detection of an error can be time-consuming. Sometimes it is also necessary to interrupt production in an installation in order to carry out further investigations into various aggregates and at various conveyor belt sections in order to determine whether the aggregates or conveyor belt sections concerned have an error (fault).

It is disadvantageous that an error detection is often only possible at a late stage. Furthermore, it is disadvantageous that a gradual performance loss cannot be detected earlier and that and that a noticeable drop in the performance of the installation must first occur as a prerequisite for a detection or an intervention by switching off the installation and investigating. Moreover, it is also disadvantageous that considerable production losses can result from downtimes.

Consequently, it is an object of the present invention to deal with one or more of the described disadvantages of known workpiece machining installations.

### INTRODUCTORY PART OF THE DESCRIPTION

One aspect of the present invention relates to a method for error detection and for local limitation of a cause of the error in an installation for machining a workpiece which is preferably formed at least in sections from wood, a wood material, and/or a synthetic material, and with the installation having several segments. A division of the installation into segments for performing the method can be suitably carried out, i.e. it can be defined, for example, that the installation is to be regarded as divided into two or more (for example, fifteen, etc.) segments.

The method comprises the steps: Detecting a status information which relates to a workpiece throughflow in at least two segments of the installation; determining whether there is an error on the basis of the status information; if an error is present, identifying in which of the at least two segments of the installation the error is present for localizing the cause of the error; and outputting a signal containing the information regarding which segment the error is in.

Preferably, it is determined whether a future performance loss of the installation is to be expected, and that there is an error if a future performance loss is expected. In this way, an error is already proactively identified (i.e., it is concluded that there is an error) if a performance loss has not even actually occurred, but rather already then if a performance loss is expected in the future (a future performance loss). In some embodiments, the performance loss is defined by the fact that a quantity of workpieces processed by the installation during a predetermined time unit falls below a predetermined threshold value. In other embodiments, the performance loss is defined as another parameter quantifying the performance of the installation or, for example, as a falling beneath a predetermined threshold value of such a parameter. In some embodiments, a performance loss is defined as the falling of such a parameter outside of a predetermined value range.

The predetermined time unit can be, for example, a minute, an hour, or a day (or another suitable unit of time). In some embodiments, a user can also predetermine or adjust the time unit itself. Thus, for example, a performance loss can be defined as the installation processing fewer than 8500 workpieces per day, etc. Preferably, the threshold value in the wood processing (in particular edge processing) is defined in a range from 7000 to 10000 workpieces per day (or an equivalent parameter).

It is preferably determined that there is an error, before the performance loss actually occurs. This means that an error is already then detected when a performance loss would only become noticeable gradually or when a performance loss is even about to occur, i.e. before an actual performance loss occurs. Before the number of pieces processed decreases, it can be detected, for example, that a reduction in the number of pieces is to be expected in the near future. On the basis of this information, proactive action can then be taken. For example, a maintenance time can be brought forward, or specific attention can be paid during a routine maintenance to the segment of the installation identified as having a fault, etc. Thus, an actual performance loss can be prevented. Often this can even be prevented, often at least weakened.

In some embodiments, the error is determined on the basis of a temporal development of detected status information. In this way, for example, tendencies can be identified at an early stage and consequently a gradual performance loss can be prevented.

The installation can have two or more segments, and in some embodiments, a status information is not detected in all segments, but rather, for example, only in two or in one other specific number of segments. In other embodiments, a status information is detected in each segment The division into segments can be thereby strongly compartmentalized—i.e., for example, such that each machining aggregate of the installation is positioned in a different segment or even such that one aggregate is assigned to several segments (and an aggregate is “segmented” itself), and/or such that different conveyor belt sections are assigned to different segments—or the division can be rough—i.e., for example such that several aggregates are arranged in one segment, etc.

The status information detected in different segments can be the same status information or different types of status information can be detected in at least two segments.

The status information relating to a workpiece throughflow is a status information associated with the dynamics of the process in the installation, i.e. not a static parameter of the installation. If the installation is operating, and consequently, workpieces are being conveyed and machined in the installation, there is a workpiece throughflow. The status information which relates to a workpiece throughflow is to be distinguished from a measured value which relates exclusively to static properties of the system or of workpieces.

Since a gradual performance loss has an effect on the workpiece throughflow, the described type of status information relating to the workpiece throughflow is a particularly suitable parameter for the early detection of a performance loss or an error (fault) in the installation. If a drop in performance occurs and the throughflow of workpieces decreases, a status information relating to the workpiece throughflow therefore changes as well. Consequently, a status information is a parameter which changes if the workpiece throughflow changes (for example, if the average number of workpieces machined or conveyed in a predetermined time unit changes).

Since status information is measured in at least two segments, it is possible, if an error occurs, to identify (in all probability) in which segment of the system an error or defect is present. Since a signal is additionally output, which displays to a person in which segment the error is occurring, the cause of the error can be efficiently limited. This is advantageous since further clarifications can be carried out location-specifically in the installation. One possibility, for example, is to temporarily switch off and examine only one part (for example, the segment having the detected error). Other parts of the installation can still be operated. In this manner, production losses can be reduced or even eliminated.

The signal can be output centrally or de-centrally. For example, a respective error signal can be output at the respective segment. Alternatively, signals for all segments can be output to a computer and/or a controller. Some or all segments in which a status information is detected can also transmit information to a different processing element, and the aforementioned different processing element then outputs a signal.

According to some preferred embodiments, the method is used with an installation which has two or more aggregates for machining or inspecting workpieces, with at least two aggregates being assigned to different segments. In this way, the cause of the error can be limited to specific aggregates. According to some embodiments, with a plurality of (for example, all) aggregates, a status information is detected and errors are searched for. This makes the error detection and cause limitation especially efficient and creates a higher local resolution of the error limitation.

According to some preferred embodiments, the identifying includes that the error is assigned to a specific aggregate or a specific part of the installation between two aggregates, and the signal that is output includes information regarding which aggregate or which part of the installation between two aggregates is faulty. A part between two aggregates or several parts between aggregates can be conveyor belt sections or can have one or more conveyor belt sections. The cause limitation for errors is especially specific in these embodiments.

According to some preferred embodiments, the detected status information is compared with an upper and/or a lower threshold value, and it is determined that there is an error if a detected status information value is larger than the upper threshold value and/or smaller than the lower threshold value. Error development tendencies can also be monitored with threshold value monitorings.

According to some preferred embodiments, the detected status information is a cycle time, in particular a quantity of conveyed workpieces per time unit, in at least one segment. The time unit is, for example, a second, a minute, an hour, a day, or another time unit that is predetermined by a user. Preferred cycle times in wood processing installations (for example an edging installation), for example, lie within a range of 5000 per day to 15000 per day, preferably 8000 per day to 12000 per day. The detected status information can also be a cycle time, in particular a quantity of conveyed workpieces per time unit, in two or more (or in all) segments. The cycle time can thereby also be different in different segments (for example, different predetermined time units). Particularly preferred is the use of the method in wood processing installations or wood material processing installations, for example, in edge coating installations.

According to some preferred embodiments, the detected status information in at least one segment is a minimum distance, a maximum distance, an assembly gap between two successive workpieces in throughflow, another parameter relating to a gap between two successive workpieces, or a time period between a first point in time at which data for an earlier workpiece is detected, and a second point in time at which data for a later workpiece is detected. This status information is excellently suited to detecting an error as well as, for example, a gradual performance loss. Detected status information in several segments can thereby also be compared. It is also possible to acquire a plurality of status information in one segment, or the same status information at several locations within the same segment.

For example, if the assembly gap between two consecutive workpieces in a certain segment decreases, it can be assumed that this aggregate is causing a delay. A gradual performance loss is thereby detected early since the cycle time for the entire installation possibly still remains unchanged despite the assembly gap becoming gradually smaller. For example, if the assembly gap becomes smaller after a gluing aggregate, this aggregate can be identified as the cause of the error, in accordance with the method. For example, a possible cause is that a glue temperature is not (or is no longer) correctly adjusted since, for example, a heating element is showing signs of wear, or that an edge pressure element is exerting too little pressure on the edges, etc.

In some embodiments, a distance between two facing edges of workpieces is measured as an assembly gap, namely from opposite corners, i.e. when viewed from above the conveyor belt, for example, from an upper left corner of the one workpiece to a facing lower right corner of the other, adjacent workpiece (or vice versa). Alternatively, a minimum distance or a maximum distance or a distance between the same corners (left and left corner or right and right corner) or from other opposite points on the edges of adjacent workpieces can be measured as well. The measurement can thereby occur with one or more sensors—for example, laser sensors.

According to some preferred embodiments, the detected status information is, in at least one segment, a time period which an aggregate had needed in order to change from an actual state into a target state. One example of this is the time period needed by an aggregate to return to its initial position or initial state after machining a first workpiece, in order to machine a second workpiece. One example of such a time period to be detected is the batch change time (the time period needed to set an aggregate to the next workpiece to be machined).

According to some preferred embodiments, an error is detected from a tendency of measurement values of one detected status information or a plurality of detected status information. In this manner, an especially proactive, early error detection can be performed. In particular, gradual performance losses can be recognized especially early, even then if these are not yet reflected in a loss of production. If, for example, the assembly gap drops by 0.1% every day at a specific conveyor belt section, the affected conveyor belt section can be inspected very early (for example during a regular system downtime of the installation) and can be serviced accordingly if necessary. Aggregates can also be dealt with correspondingly.

One further aspect of the present invention lies in the use of the method according any one of the above-described embodiments (or a combination of different embodiments) in an edging installation for machining an edge of a workpiece and/or for applying an edge element to a workpiece. In such an edging installation, an early error detection and a limitation of the cause of the error is particularly advantageous since large cycle times (for example, 8000-12000 workpieces per day) are reached, and consequently, an additional downtime leads to a perceivable performance loss.

The invention also relates to a data carrier on which a program is stored which is suited to being executed on a data processing system which can be operated together with an installation for machining a workpiece which is preferably formed at least in sections from wood, a wood material and/or a synthetic material, so that the method is carried out in accordance with any one or several of the preceding embodiments. Thus, an existing controller of an installation can be equipped with the program, so that the controller can contribute to the performance of the method.

The invention also relates to a sensor equipment set for equipping an installation for machining a workpiece which is preferably formed at least in sections from wood, a wood material, and/or a synthetic material, with a sensor system for setting up the installation to perform a method for detecting an error and for local limitation of an error, with the sensor system having a plurality of sensors suited to detecting status information relating to a workpiece throughflow.

With the sensor equipment set, an installation which is not suited to performing the method according to one of the previously described aspects or one or several of the described embodiments can be retrofitted so that the method can be performed. It can therefore be avoided that installations need to be completely replaced in order to be able to perform a more proactive early error detection. This is particularly advantageous since sensors that are already present in installations are not optimally positioned to capture status information related to workpiece throughflow and the existing sensor type is often not adjusted for a workpiece throughflow status information detection either. On the other hand, the sensor equipment set can be provided with sensors of the type or those types which are especially suited for the detection of status information (for example, laser sensors), and the sensors can be applied to locations at which a status information is supposed to be detected. For example, in one or more segments, one or more sensors can be arranged above and/or below the conveyor belt, and one or more sensors can be arranged in one or more aggregates (or, if desired, in any aggregate of the installation).

According to some preferred embodiments, the sensor equipment set has at least one sensor unit having at least one of the sensors of the set, with the sensor unit being configured to transmit a signal to a receiver via a cable connection or wirelessly. The part of the unit which is configured to send data can thereby be formed integrally with the sensor or as a separate component, or as separate components.

Several preferred embodiments of the sensor equipment set or sensor retrofitting set further have a previously-described data carrier. Consequently, the sensor retrofitting set can be used to equip an installation with the sensors necessary for acquiring desired workpiece throughflow status information as well as to enable a data processing system to work together with the installation and the sensors in order to operate the method according to the invention or a further development thereof in the operating installation.

One aspect of the invention relates to an installation for machining a workpiece which is preferably formed at least in sections from wood, a wood material, and/or a synthetic material, with the installation having several segments and each segment having at least one sensor for detecting a status information which relates to a workpiece throughflow. The installation further has a controller that is configured to perform the method according to one of the previously described aspects.

According to several embodiments, the installation is provided with a sensor equipment set according to one of the above-described aspects.

### BRIEF DESCRIPTION OF THE FIGURES

In the following, preferred embodiments of the present invention will be described with reference to the figures.

FIG. 1 is a schematic view of an installation for machining a workpiece.

FIG. 1 is a schematic view of an installation 100 for machining a workpiece w that is formed at least in sections from wood or a wood material. Specifically, the shown installation 100 is an edging installation for applying solid wood edges or paper edges to wooden workpieces or wood material workpieces. However, the present disclosure is in no way restricted to installations of this type or to the performance of methods in installations of this type.

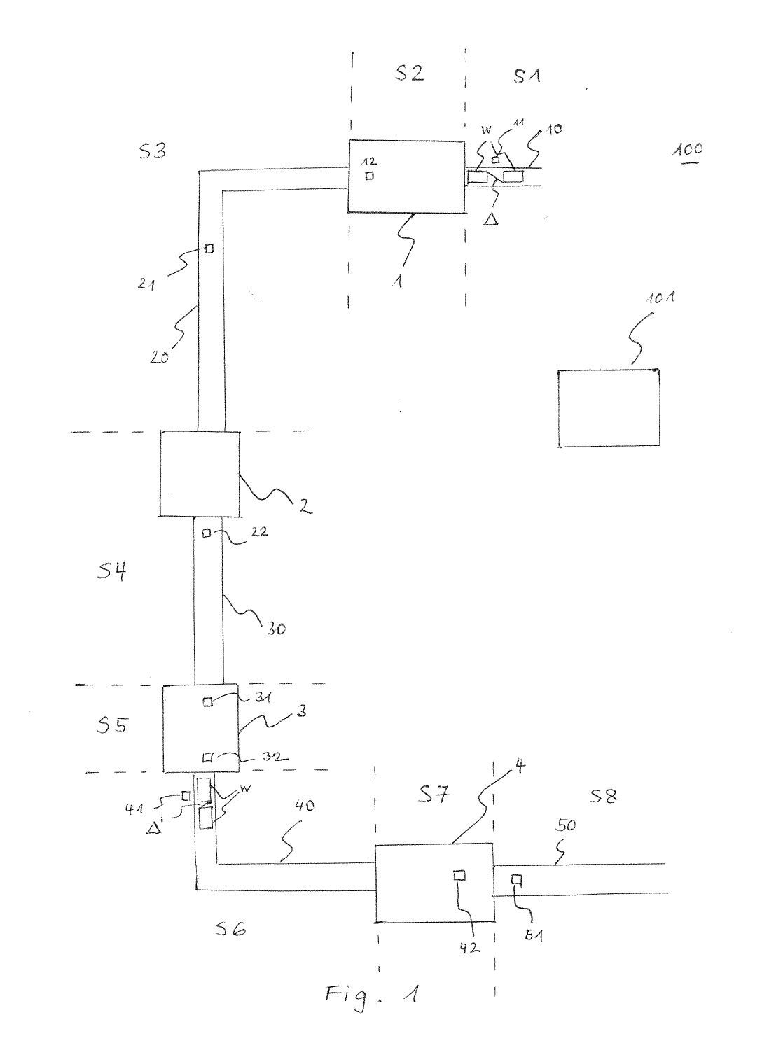

To perform a method for detecting an error and for local limitation of a cause of the error in the installation 100, the installation 100 is divided into segments. In some embodiments, the total number of segments is two, in other embodiments, the number is higher, possibly even significantly higher. The installation of FIG. 1 is divided into eight segments, S1 to S8.

The installation 100 furthermore has four machining aggregates 1, 2, 3, 4, for machining workpieces—in this installation, for applying edges to workpieces. Other embodiments can have a diverging number of machining aggregates. Moreover, installations in which the method is performed can has also have inspection aggregates and/or aggregates which carry out one or more machining functions and/or inspection functions. One example for an aggregate is an edge coating aggregate that applies an edge to a wood workpiece, for example, when manufacturing a table. Other examples are a sawing aggregate, a drilling aggregate, a milling aggregate, a gluing aggregate and/or a welding aggregate.

In the case of FIG. 1, all aggregates 1 to 4 are assigned to different segments, namely segments S2, S4, S5 and S7. In other embodiments, a segment can also have two or more aggregates.

The first segment S1 has a conveyor belt section 10 which leads to the first machining aggregate 1. The second segment S2 has the first machining aggregate 1. The third segment S3 has a further conveyor belt section 20 which leads from the first machining aggregate 1 to the second machining aggregate 2. The fourth segment S4 has the second machining aggregate 2 as well a further conveyor belt section 30 which leads from the second machining aggregate 2 to the third machining aggregate 3. In other embodiments, the installation is, on the other hand, more finely divided such that each aggregate is assigned to its own segment. In other embodiments, several belt portions and possibly also one or more aggregates are, in turn, assigned to the same segment.

The fifth segment S5 has the third machining aggregate 3. The sixth segment S6 has a further conveyor belt section that leads from the third machining aggregate 3 to the fourth machining aggregate 4. The seventh segment S7 has the fourth machining aggregate 4. The eighth segment S8 lastly has a conveyor belt section 50 which leads downstream from the fourth machining aggregate 4 with respect to the workpiece throughflow direction.

A high throughflow of workpieces takes place in the installation 100. In this embodiment, between 10000 and 12000 machined workpieces are transported on the belt section 50 during normal operation of the installation 100. The goal is to avoid a significant performance drop (so that at some point in time, for example, less than 10000 pieces per day will be machined).

The installation 100 also further has a controller 101 which controls an operation of the installation 100. Among other things, this embodiment includes regulations of aggregates and conveyor belt sections The controller 101 communicates wirelessly with aggregates and collects data information from sensors that are arranged in the aggregates.

Moreover, the installation 100 is equipped with special sensors which serve to perform the error detection method. For this, the installation was equipped with a sensor retrofitting set (not shown) which has sensors that are suited to detecting a status information or a plurality of status information relating to a workpiece throughflow, as well as a data carrier (not shown) upon which a program is stored which is suited to be performed with the controller 101 so that the controller 101 together with the other components of the installation 100 carries out the error detection method to be described.

For this, the sensor 11 is arranged above the conveyor belt section 10 in the first segment S1. Furthermore, a sensor 12 is arranged in the first aggregate 1 (i.e. in the second segment S2). A sensor 21 is arranged at the belt section 20 in the third segment S3. A further sensor 22 is arranged at the belt section 30 in the fourth segment S4, directly downstream from the second aggregate 2. The fifth segment S5 has further sensors 31 and 32 in the third aggregate 3. A sensor 41 is also arranged above the conveyor belt section 40 in the sixth segment S6. The seventh segment S7 has a sensor 42 in the fourth aggregate 4, and a sensor 51 is also arranged in the eight segment S8 at the belt section 50.

All of the aforementioned additional sensors 11, 12, 21, 22, 31, 32, 41, 42 and 51 (“additional” to those already in a conventional installation which are not formed to perform the error detection according to this disclosure) are suited to detecting a status information which relates to a workpiece throughflow. The status information to be detected is thereby not the same for all of the aforementioned sensors 11 to 51.

For example, the sensors 22, 32 and 51 are formed to detect a cycle time, namely the number of conveyed workpieces w per time unit. The sensors 22 and 51 thereby detect the cycle time on the conveyor belt, whilst the sensor 32 in aggregate 3 detects cycle times.

The sensor 11 is configured to detect an assembly gap Δ on the conveyor belt 10, namely an assembly gap defined as a diagonal, i.e. a distance from facing yet not opposite edges of successive workpieces. This means that, for example, (in the drawing plane of FIG. 1) the distance between the upper right corner of the left (downstream) workpiece and the lower left corner of the right (upstream) workpiece is detected (as schematically shown in FIG. 1). The assembly gap value can thereby, for example, be in the meter, centimeter, millimeter or micrometer range, and detected

The sensor 41 is also configured to detect an assembly gap Δ′, with the difference of the detected values Δ and Δ′ or the development of a difference value Δ−Δ′ being able to indicate an error over the course in time.

On the other hand, in this embodiment, the sensor 21 is configured to detect a minimum and a maximum distance between two workpieces. The sensor 21 can, for example, provide indications regarding an inclined position of workpieces on the conveyor belt section 20. If an inclined position is suspected after a corresponding error message has been output, it can be examined, for example, whether a positioning element which positions the workpieces on the conveyor belt or holds them in position has a fault.

The sensor 31 for detecting a time period is configured between a first point in time at which data for an earlier workpiece is detected, and a second point in time at which data for a later workpiece is detected. The earlier and later workpieces here in the conveyor series are thereby successive workpieces However, the sensor can also be used, for example, in order to detect, for example, the time period between points in time, which lies between points in time which, for example, are associated with the measurements at each fifth or each tenth (or a user pre-set, arbitrary, other quantity of) conveyed workpieces.

The sensor 42 in aggregate 4 is configured to a detect a batch change duration, i.e. a time period that an aggregate needs in order to reach a target state from an actual state. After machining a workpiece, the aggregate 4 must always be returned to the initial state for a specific machining or a machining step, before the machining of the next workpiece can commence. The batch change time can be, for example, within a range of seconds, a range of milliseconds or a range of nanoseconds.

In this embodiment, the controller 101 is configured to constantly check whether the measured assembly gaps are large enough so that no delays in the conveyor belt process are to be expected owing to the measured batch change durations at sensor 42. If a gradual performance loss is becoming apparent and delays are to be expected in the future, an error message is issued proactively.

More generally, in these embodiments of an installation 100, the described sensors 11, 12, 21, 22, 31, 32, 41, 42 and 51 are each connected with corresponding units (these units together with the respectively associated sensor forming so-called sensor units) that are configured to transmit data to the controller 101 via a wireless communication. The controller 101 continuously receives this data and processes the data. In other embodiments, the communication with all sensor units or with a part thereof is implemented via a cable connection. In this embodiment, the controller 101 has a receiver which is suited to receive the wirelessly transmitted data.

The installation 100, and in particular the controller 101, are configured to perform a method for the detection of an error in the installation 100 and the local limitation of a cause of the error.

The method comprises the respective detection of the above-described status information that relates to a workpiece throughflow, with each of the sensors 11, 12, 21, 22, 31, 32, 41, 42 and 51 in the segments S1 to S8 of the installation 100.

The status information is always transmitted to the controller 101, and in this embodiment, for each of the transmitted values of the respective status information it compares whether the value is beneath a lower threshold value or if it exceeds an upper threshold value. Thus, it is checked, for example, whether the assembly gap Δ detected by the sensor 11 falls into a target assembly gap range, and whether the assembly gap Δ′ detected by the sensor 41 falls into a target assembly gap range. Additionally, it is also compared between the detected values, i.e. for example between the assembly gap Δ and the assembly gap Δ′. The course in time of this difference value is monitored in order to detect gradual tendencies. Furthermore, temporal developments of measured values are also monitored with the same sensor in order to detect statistically significant developments of the measurement values (or other statistical quantities, such as the mean or the median of the detected values)—for example, developments in a certain direction, such as a statistical decrease of the values or a statistical increase.

Depending on the detected and transmitted status information values, the controller 101 determines whether there is an error. In this embodiment, an error is thereby not concluded alone from the presence of a deviation of a value from a target range, but rather threshold values can be set for deviations or for deviation tendencies. For example, it can therefore be determined that an error is present at sensor 41, if during a longer time period, the assembly gaps A′ deviate by a threshold value or more from the assembly gaps A that have been measured upstream. Alternatively, an error can also be concluded if, for example, the assembly gap values have increased on average by more than one specific predetermined value (for example, by more than 0.3% percent). Furthermore in this embodiment, it is also monitored whether the averaged measurement values over a time period of 20 minutes diverge by more than 0.3% from the previous average in a time period of 20 minutes. In addition, the variance of the detected values for each sensor is also monitored separately, and correlations between detected values for different sensors are also monitored. On the basis of such types of monitoring, a gradual performance loss can be detected highly efficiently.

In more general terms, the method comprises determining that there is an error, based on the status information experienced. The method also comprises, if there is an error, the step of identifying in which of the at least two segments of the installation (in which values were detected) the error is, for local limitation of the cause of the error. This step is carried out with this embodiment of the controller 101.

In the embodiment of FIG. 1, for example, a limitation of the cause of the error is carried out from the information at which sensor unusual values for the status information have been determined. For example, in some embodiments, the fact that a sensor in segment S delivers different values leads to the conclusion that the error is in segment S. On the other hand, in other embodiments, and therefore also in the embodiment of FIG. 1, an error owing to a sensor in one segment can indicate the presence of an error source in a different installation segment. For example, serves the detection of a too-small assembly gap at sensor 41 in segment S6. If it is simultaneously determined that in segments S1 to S4, “normal” status information was detected, the cause of the error is limited to segment S5. In this way, the information from one single sensor is not viewed in isolation, but rather a well-founded conclusion regarding local error source limitation is made by the method owing to measurement values from a plurality of sensors.

Furthermore, the method comprises outputting a signal that contains the information regarding which segment the error is in. In the present embodiment, the signal is output by the controller 101. On the basis thereof, the operating staff of the installation 100 in this embodiment are displayed on a display of a data processing system an error message which particularly states in which segment of the installation 100 a fault is suspected. Furthermore, with this embodiment it is also displayed which further measures would be expedient in order to deal with a fault (for example: “Replace heating element for gluing aggregate within one week” etc.). In other embodiments, acoustic signals are output, for example, at certain positions in the installation. Alternatively or additionally, optical warnings can also be output. Thus, for example, a light can show that an error source is suspected in the third segment, etc.

In the method carried out at the installation according to the embodiment of FIG. 1, the identifying includes that the error is assigned to one specific aggregate or one specific part of the installation between two aggregates (the part between the aggregates can be or can contain, for example, a conveyor belt section), and the signal output from the controller 101 contains the information regarding which aggregate or which part of the installation between two aggregates is faulty. In other words, in this embodiment, the error is assigned to one of the belt sections 10, 20, 30, 40, 50, or one of the aggregates 1, 2, 3, or 4.

In other embodiments the local resolution of the error limitation is higher—thus, for example, an error can be assigned to one specific part of the aggregate or of a conveyor belt section—in turn, it is lower in other embodiments—thus, for example, an error is assigned to the part of the installation upstream from a specific point, etc.). The resolution of the error source allocation can also vary, depending on which type of error has been detected.

The invention also covers numerous modifications and modified embodiments of the different aspects described.

What is claimed is:

1. A method for error detection and for local limitation of a cause of the error in an installation for machining a workpiece, the installation having several segments, comprising the steps:
detecting a status information which relates to a workpiece throughflow, in at least two segments of the installation;
determining, on the basis of the status information, whether there is an error with respect to the installation;
if there is an error, identifying which of the at least two segments of the installation the error is in, for local limitation of the cause of the error; and
outputting a signal that contains information regarding which segment the error is in.

2. The method according to claim 1, wherein the workpiece is formed at least in sections from wood, a wood material, and/or a synthetic material.

3. The method according to claim 1, wherein determining whether there is an error comprises determining whether a future performance loss of the installation is to be expected, and that there is an error if a future performance loss is expected.

4. The method according to claim 1, wherein the performance loss is defined as a falling beneath a predetermined threshold value of a quantity of workpieces processed by the installation during a predetermined time unit or as another parameter quantifying the performance of the installation.

5. The method according to claim 1, wherein the presence of an error is determined before the performance loss actually occurs.

6. The method according to claim 1, wherein the error is determined on the basis of a temporal development of a plurality of detected status information.

7. The method according to claim 1, wherein the installation has two or more aggregates for machining or inspecting workpieces and at least two aggregates are assigned to different segments.

8. The method according to claim 7, wherein the identification includes that the error is assigned to a specific aggregate or a specific part of the installation between two aggregates, and the output signal contains the information regarding which aggregate or which part of the installation between two aggregates is faulty.

9. The method according to claim 1, wherein the detected status information in at least one segment is a cycle time.

10. The method according to claim 9, wherein the cycle time is a quantity of conveyed workpiece per time unit.

11. The method according to claim 1, wherein the detected status information in at least one segment is a minimum distance, a maximum distance, an assembly gap between two successive workpieces in throughflow, another parameter relating to a gap between two successive workpieces, or is a time period between a first point in time at which data for an earlier workpiece is detected, and a second point in time at which data for a later workpiece is detected.

12. The method according to claim 1, wherein the detected status information in a least one segment is a time period which an aggregate had needed in order to change from an actual state into a target state.

13. The method according to claim 12, wherein the time period is a batch change time duration.

14. The method according to claim 1, wherein an error is recognized from a tendency of measurement values of a detected status information or a plurality of detected status information.

15. The method according to claim 1, wherein the detected status information is compared with an upper and/or a lower threshold value and it is determined that there is an error if a determined status information value is greater than the upper threshold value and/or is less than the lower threshold value.

16. A use of the method according to claim 1 in an edging installation for machining an edge of a workpiece and/or for applying an edge element to a workpiece.

17. A data carrier upon which a program is stored which is suited to be executed on a data processing system which can be operated together with an installation for machining a workpiece, so that the method is carried out according to claim 1.

18. The data carrier according to claim 17, wherein the workpiece is formed at least in sections from wood, a wood material, and/or a synthetic material.

19. Sensor equipment set for equipping an installation for machining a workpiece, with a sensor system for setting up the installation to perform a method for detecting an error and for local limitation of an error, the sensor system having a plurality of sensors suitable for the detection of a status information relating to a workpiece throughflow.

20. The sensor equipment set according to claim 19, wherein the workpiece is formed at least in sections from wood, a wood material, and/or a synthetic material.

21. The sensor equipment set according to claim 19, comprising at least one sensor unit having at least one of the sensors, the sensor unit being configured to transmit a signal to a receiver via a cable connection or wirelessly, the sensor equipment set having a data carrier.

22. An installation for machining a workpiece that is formed at least in sections from wood, a wood material, and/or a synthetic material, the installation having several segments and each segment having at least one sensor for acquiring a status information which relates to a workpiece throughflow, characterized in that the installation further has a controller which is configured to carry out the method according to claim 1.

23. The installation according to claim 22 which is provided with a sensor equipment set for equipping an installation for machining a workpiece which is formed at least in sections from wood, a wood material, and/or a synthetic material, with a sensor system for setting up the installation to perform a method for detecting an error and for local limitation of an error, the sensor system having a plurality of sensors suitable for the detection of a status information relating to a workpiece throughflow.
